(19) United States
(12) Patent Application Publication
(10) Pub. No.: US 2011/0146081 A1
(43) Pub. Date: Jun. 23, 2011

(54) RAZOR

(76) Inventor: Oleg Yurievich Solomennikov, Noginsk (RU)

(21) Appl. No.: 13/058,967

(22) PCT Filed: Dec. 17, 2008
(86) PCT No.: PCT/RU2008/000773

§ 371 Date: Feb. 14, 2011

(30) Foreign Application Priority Data
Aug. 12, 2008 (RU) 2008132961

(51) Int. Cl. B26B 21/28

(52) U.S. Cl. 30/48

(57) ABSTRACT

The invention relates to hand-held portable cutting tools, in particular to safety razors. The razor comprises a holder with a handle and at least one pair of blades. The blades are arranged in the holder at an acute angle symmetrically to the razor longitudinal axis. A transverse jumper is made in the center of the holder. Said jumper fixes the position of blades. The setting angle of the blades ranges from 75 to 80°. In preferred variant, the razor comprises two or more pares of blades having different setting angles. Preferably, not more than four. It is reasonable to design the razor in such a way that the setting angle of each preceding pair of blades in the direction of the razor motion is greater than the setting angle of the next pair of blades. The invention makes it possible to increase the efficiency and ease of shaving and to reduce the production cost of the razor.

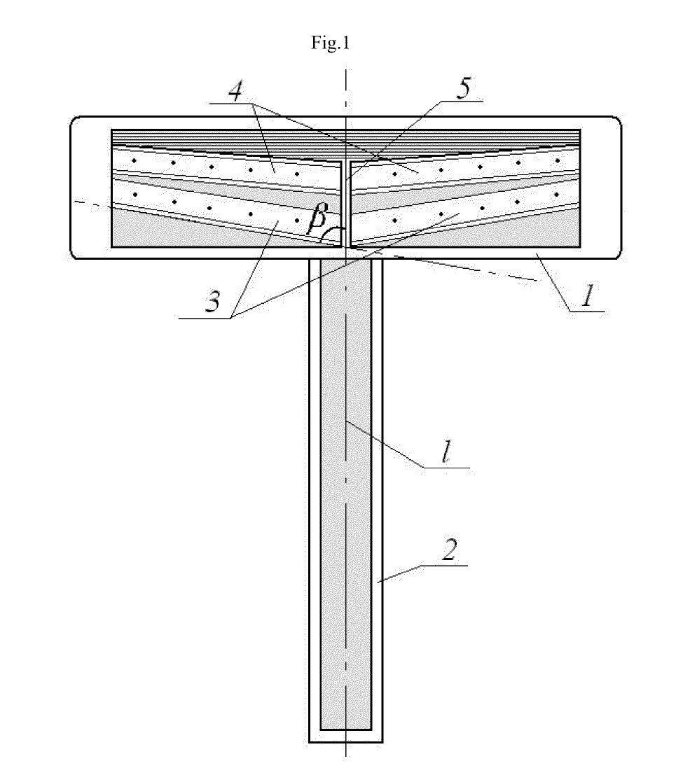

The useful model is related to portable cutting tools, namely to safety razors.

Known is a razor, which contains a holder with handle and at least one pair of blades installed in the holder at a sharp angle symmetrically about the longitudinal axis of the razor (see patent RU 2161088, C1. B26B21/00, published Dec. 27, 2000). Disadvantages of the known device are the unreliable locking of blades located in the central part of the holder, presence of sharp cutting angle within this section and non-optimal selection of blade setting angle. Affording the opportunity to the customer to control the angle independently is not satisfactory solution of the problem. The retainer holding the blade in the selected position wears out in the course of time and can not ensure the reliable securing. Besides the user is not a specialist in the efficiency of the selected angle setting and optimal angle shall be determined for maximum convenience during multiple checks conducted during production of the razor.

The task of the useful model is to eliminate the said disadvantages. The technical result consists in increase of comfort and economy of the shaving, as well as in reduction of material expenses for production of the razor. The assigned task is solved and the technical result is achieved by the fact that the razor contains the holder with the handle and at least one pair of blades installed in the holder at a sharp angle symmetric about the razor axis. In this case a cross jumper is made in the razor center, which fixes the blade setting and the blade setting angle is within 75-80°.

It is preferably that the razor contains two and more pairs of blades with different angle setting better four not more. It is expedient that the setting angle of each previous pair of blades in the direction of the razor movement exceeds the setting angle of the next pair of blades.

The drawing presents the schematic image of the razor.

The razor contains holder 1 with handle 2. A pair of blades is installed in holder 2 at sharp angle β symmetric about longitudinal axis 1 of the razor. Setting angle β is within 75-80°. The number of pairs may reach four, for image simplicity, the drawing shows the razor variant with two pairs of blades 3 and 4. The angle of setting each previous pair in the direction of the razor movement exceeds the setting angle of the next pair, as blade 3 setting angle β may be made equal 75° and angle of blades 3 setting angle β—80°. The holder center carries cross jumper 5, which fixes the blade setting.

The razor operates as follows:

While the razor moves along the surface being processed the hairs are shifted along the cutting edge, thus increasing the cutting capacity of the blade. Thus, the requirements for grinding and quality of the blade steel imposed upon the traditional razors with blades perpendicular to the longitudinal axis are reduced. Besides the traditional location of the cutting edge at straight angle brings about to its quick wear-out and respectively to reduction of the shaving quality.

The made tests showed that the setting angle of 75-80° is optimal. At a greater angle the hair shifting effect along the blade edge practically disappears and the razor becomes traditional. At a smaller angle the probability of the skin cut gets increased which adversely affects the shaving comfort degree.

The symmetrical setting of blades at an angle to the longitudinal axis of the razor forms the sharp cutting edge in the holder center, which is able to hurt the skin. If the razor contains several pairs of blades, each of which passes the upper (respectively to the drawing) edge of the holder to the lower edge, a region is formed in the center, which is processed first in the direction of the razor movement. Thus its efficiency is sharply reduced in the center of the processing zone. The said disadvantages are eliminated if the a cross jumper is located in the holder center, which camouflages the sharp cutting edge.

According to researches made the setting from 2 to 4 pairs of blades in the razor is optimal. Such location of these pairs at different angles makes it possible to effectively cut the hairs growing in different directions. Hairs are better shaved when moving the razor opposite the direction of the hair growth. In this case if the setting angle of the first pair of blades in direction of movement is maximum, the majority of hairs are immediately cut out at the optimal angle. The second blade located at smaller angle shaves hairs growing at a small angle to the direction of the main growth. The third blade shaves hairs growing at a greater angle and so on. In this case the said sequence of the setting angles provides for maximum efficiency of shaving at the first stage and further shaving quality by next blades. If the blades are set in reverse order, the shaving quality is sharply reduced.

Thus the useful model males it possible to sufficiently increase the efficiency and comport of the shaving, making it almost painless, as well as to reduce the material expenses for production of the razor as it makes it possible to use blades with grinding and from steel of lower quality.

1. The razor, containing the holder with the handle and at least one pair of blades installed in the holder at sharp angle symmetrical about the razor axis, differing by that the cross jumper is made in the holder center, which fixes the blade settings and the blade setting angle is within 75-80°.

2. The razor against Item 1, differing by that it contains two and more pairs of blades with different setting angles.

3. The razor against Item 2, differing by that it contains no more than four pairs of blades.

4. The razor against Item 2, differing by that the setting angle of each blade pair in the direction of the razor movement exceeds the setting angle of the next blade pair.
